(19) United States
(12) Patent Application Publication
(10) Pub. No.: US 2009/0268892 A1
(43) Pub. Date: Oct. 29, 2009

(54) COMMUNICATION TERMINAL AND METHOD FOR PROVIDING COMMUNICATING STATUSES OF PHONE NUMBERS IN ELECTRONIC PHONEBOOK THEREOF

(75) Inventors: SHIH-FANG WONG, Tu-Cheng (TW); AN-AN PAN, Shenzhen City (CN); RUI-PING ZHOU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/430,907

(22) Filed: Apr. 28, 2009

(30) Foreign Application Priority Data
Apr. 28, 2008 (CN) 200810301338.5

(51) Int. Cl. H04M 15/06

(52) U.S. Cl. 379/142.06

(57) ABSTRACT

A communication terminal includes an electronic phonebook, a status requesting unit, a communication unit and an updating unit. The electronic phonebook records phone numbers, and a communicating status corresponding to each of the phone numbers. The status requesting unit generates a request of reading the communicating statuses of the monitored phone numbers in the electronic phonebook. The communication unit transmits the generated request to a communication switching center and receives the communicating statuses of the monitored phone numbers transmitted by the communication switching center. The updating unit updates the communicating statuses of the monitored phone numbers according to the received communicating statuses.

### BACKGROUND

1. Technical Field

The present disclosure relates to communication, and more particularly to a communication terminal and a method for providing communicating statuses of phone numbers in an electronic phonebook of the communication terminal.

2. Description of Related Art

As communication technology develops, communication terminals, such as handsets, are widely used in people's life so that people communicate with each other conveniently. An electronic phonebook is usually stored in a communication terminal. A series of phone numbers may be listed in the electronic phonebook. Users can directly communicate with another communication terminal through the electronic phonebook without manually inputting the corresponding phone number. This is quite convenient for users. However, users may want to know a communicating status of a phone number before dialing the phone number.

Therefore, there is room for improvement within the art.

### BRIEF DESCRIPTION OF THE DRAWINGS

FIG. 1 is a block diagram of a communication system in accordance with an exemplary embodiment.

FIG. 2 is a flowchart of a method for providing communicating statuses of phone numbers in an electronic phonebook of a communication terminal in accordance with an exemplary embodiment.

### DETAILED DESCRIPTION

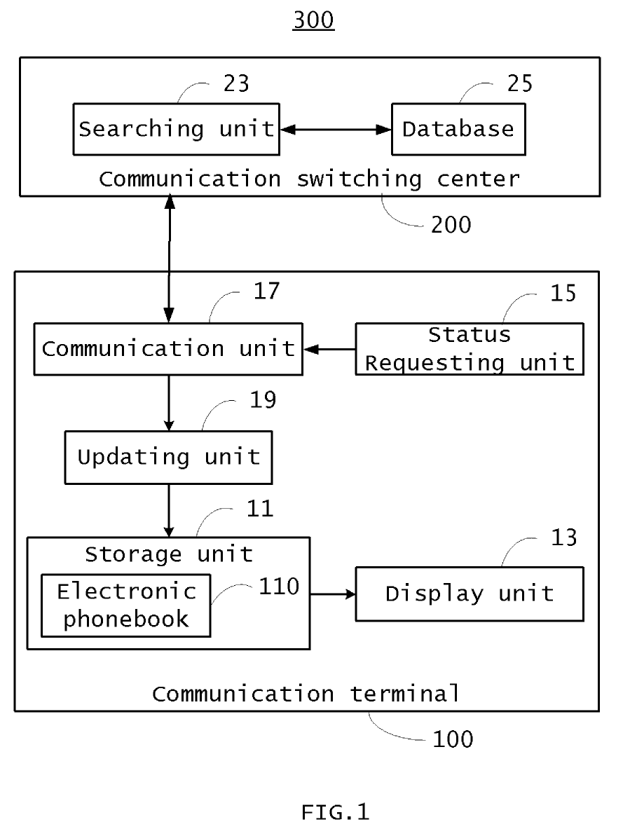

Referring to FIG. 1, a communication system 300 includes a communication switching center 200 and a communication terminal 100 capable of communicating with the communication switching center 200. The communication switching center 200 may be a mobile switching center or a communication network formed by many mobile switching centers or other switching centers or both. An application range of communication system 300 is determined by the communication switching center 200, which may be local to the personnel in a factory, citywide, or even countrywide. In this embodiment, the communication switching center 200 is a mobile switching center.

The communication switching center 200 includes a database 25 and a searching unit 23 connected to the database 25. The database 25 is used for storing phone numbers and a communicating status of each of the phone numbers. The communicating statuses of the phone numbers may be: in service, out of service, busy, etc.

The communication terminal 100, such as a handset, includes a storage unit 11, a display unit 13, a status request unit 15, a communication unit 17, and an updating unit 19. An electronic phonebook 110 stored in the storage unit 11 is used for recording contact names, corresponding phone numbers, and communicating statuses of the phone numbers.

The display unit 13 is used for displaying information recorded in the electronic phonebook 110. Different colors may be used to denote different communicating statuses of the phone numbers. For example, the phone numbers displayed in red color may denote that the communicating statuses of these phone numbers are out of service; the phone numbers displayed in yellow color may denote that the communicating statuses of these phone numbers are in service.

The status requesting unit 15 is used for generating a request of reading the communicating statuses of the corresponding monitored phone numbers in the electronic phonebook 110. The monitored phone numbers are can be predetermined. The status requesting unit 15 may generate the request periodically according to a predetermined period according to user preference via the communication terminal 100.

The communication unit 17 is used for transmitting the request to the communication switching center 200 and receiving the communicating statuses of the monitored phone numbers from the communication switching center 200. In the communication switching center 200, the searching unit 23 may be used for reading the communicating statuses corresponding to the monitored phone numbers from the database 25 and transmitting the communicating statuses to the communication unit 17 in response to the request.

The updating unit 19 is used for updating the communicating statuses of the monitored phone numbers in the electronic phonebook 110 according to the received communicating statuses corresponding to the monitored phone numbers from the communication unit 17. Thus, the communicating statuses of the monitored phone numbers in the electronic phonebook 110 can be known via the communication terminal 100 without dialing the phone numbers.

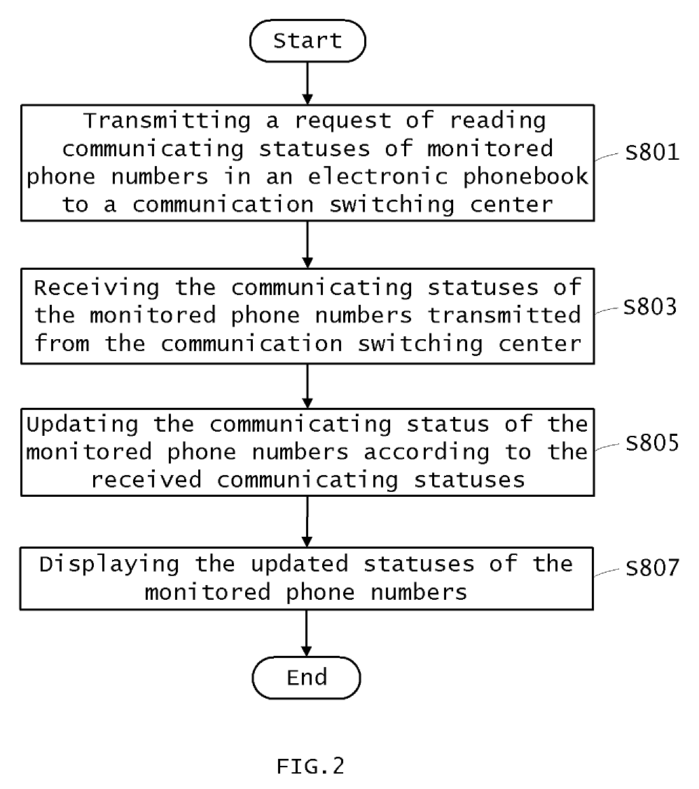

Referring to FIG. 2, a method for providing communicating statuses of phone numbers in an electronic phonebook of a communication terminal in accordance with an exemplary embodiment is shown. The method may be implemented using the communication system 300 (FIG. 1).

In step S801, transmitting a request of reading communicating statuses corresponding to monitored phone numbers in an electronic phonebook of a communication terminal to a communication switching center. The monitored phone numbers are predetermined. The request may be generated periodically according to a predetermined period according to user preference via the communication terminal.

In step S803, receiving the communicating statuses of the monitored phone numbers transmitted from the communication switching center. It may be understood that the communication switching center includes a database and a searching unit connecting to the database. The database may be used for storing phone numbers and a communicating status of each of the phone numbers. The searching unit may be used for reading the communicating statuses corresponding to the monitored phone numbers from the database and transmitting the read communicating statuses to the communication terminal.

In step S805, updating the communicating statuses of the monitored phone numbers in the electronic phonebook according to the received communicating statuses corresponding to the monitored phone numbers from the communication switching center.

In step S807, displaying the updated communicating statuses of the monitored phone numbers. Different colors may be used to denote different communicating status of the phone numbers. For example, the phone numbers displayed in red color may denote that the communicating statuses of these phone numbers are out of service; the phone numbers displayed in yellow color may denote that the communicating statuses of these phone numbers are in service. Thus, the communicating statuses of the monitored phone numbers in the electronic phonebook can be known via the communication terminal without dialing the phone numbers.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A communication terminal comprising:
an electronic phonebook with recorded phone numbers, and a communicating status corresponding to each of the phone numbers;
a status requesting unit capable of generating a request of reading the communicating statuses of monitored phone numbers in the electronic phonebook;
a communication unit capable of transmitting the generated request to a communication switching center and receiving the communicating statuses of the monitored phone numbers transmitted by the communication switching center; and
an updating unit capable of updating the communicating statuses of the monitored phone numbers according to the received communicating statuses.

2. The communication terminal according to claim 1, further comprising a storage unit, wherein the electronic phonebook is stored in the storage unit.

3. The communication terminal according to claim 1, wherein the status requesting unit generates the request periodically according to a predetermined period.

4. The communication terminal according to claim 1, further comprising a display unit, wherein the display unit displays the communicating statuses of the phone numbers.

5. The communication terminal according to claim 4, wherein different colors are used to denote different communicating statuses of the phone numbers.

6. The communication terminal according to claim 5, wherein the colors are font colors of the displayed phone numbers.

7. The communication terminal according to claim 1, wherein the monitored phone numbers are predeterminedly selectable.

8. The communication terminal according to claim 1, wherein the communication switching center includes a database and a searching unit connecting to the database, the database stores phone numbers and a communicating status of each of the phone numbers, and the searching unit reads the communicating statuses of the requested phone numbers from the database and transmits the read communicating statuses to the communication terminal.

9. A method for providing communicating statuses of phone numbers in an electronic phonebook of a communication terminal, comprising:
transmitting a request of reading the communicating statuses of monitored phone numbers in the electronic phonebook to a communication switching center;
receiving communicating statuses of the monitored phone numbers transmitted from the communication switching center; and
updating the communicating statuses of the monitored phone numbers according to the received communicating statuses.

10. The method according to claim 9, wherein the request is generated periodically according to a predetermined period.

11. The method according to claim 9, further comprising:
displaying the updated communicating statues of the monitored phone numbers.

12. The method according to claim 11, wherein different colors are used to denote different communicating statuses of the phone numbers.

13. The method according to claim 12, wherein the colors are font colors of the displayed phone numbers.

14. A communication terminal, comprising:
a communication unit for communicating with a communication switching center;
a memory electrically connected with the communication unit; and
an electronic phonebook stored in the memory adapted to record contact information, the contact information comprising phone numbers, and communicating statuses of the phone numbers which are provided from the communication switching center by the communication unit.

15. The communication terminal according to claim 14, wherein the communicating statuses are automatically and periodically updated.

16. The communication terminal according to claim 14, further comprising a display unit, the contact information recorded in the electronic phonebook is capable of being displayed by the display unit.

17. The communication terminal according to claim 14, wherein the communicating statuses comprise a plurality of kinds: out of service, in service and busy.

18. The communication terminal according to claim 17, wherein different colors are used to display different kinds of the communicating statuses of the phone numbers.

19. The communication terminal according to claim 14, wherein the communication switching center is a mobile switching center.
